(19) United States
(12) Patent Application Publication
(10) Pub. No.: US 2011/0199336 A1
(43) Pub. Date: Aug. 18, 2011

(54) OPTICAL TOUCH DEVICE

(75) Inventors: Ming Tsan Kao, Hsinchu County (TW); Wen Yu Yang, Hsinchu County (TW)

(73) Assignee: PixArt Imaging Inc., Hsinchu County (TW)

(21) Appl. No.: 12/917,100

(22) Filed: Nov. 1, 2010

(30) Foreign Application Priority Data
Feb. 12, 2010 (TW) 099203298

(51) Int. Cl. G06F 3/042

(52) U.S. Cl. 345/175

(57) ABSTRACT

An optical touch device is presented. When the optical touch device is in a sleep mode, only one of all image sensors of the optical touch device is enabled to detect an indication object on a touch area, so as to determine a wakeup time of the entire optical touch device.

### CROSS-REFERENCE TO RELATED APPLICATIONS

This non-provisional application claims priority under 35 U.S.C. §119(a) on Patent Application No(s). 099203298 filed in Taiwan, R.O.C. on Feb. 12, 2010, the entire contents of which are hereby incorporated by reference.

### BACKGROUND OF THE INVENTION

1. Field of Invention

The present invention relates to a mechanism for waking up an electronic device from a sleep mode, and more particularly to an optical touch device.

2. Related Art

As more and more attentions are paid to green energy, a power-saving design has been considered necessary for electronic devices. Moreover, requirements on current consumption of the electronic devices in a power-saving mode become stricter.

A sleep mode is a power-saving mode of the electronic devices. While an electronic device is in the sleep mode, when a user wants to use the electronic device again, the electronic device may continue to work in full power very quickly (usually in a few seconds).

With the development of technologies, touch screens are used in more and more electronic devices (such as computers and mobile devices) as interfaces.

The touch screen is an induction-type liquid crystal display (LCD) device that is capable of receiving input signals from an indication object (such as a finger or a plastic pen point). When the indication object touches a round button displayed on the touch screen, a touch feedback system of the touch screen may drive various application programs linked thereto according to pre-programmed programs.

In recent years, the optical screen has developed from the resistance type and capacitance type to the optical type. The optical touch screen uses an optical sensor to detect the indication object that touches the screen.

In order to save power, when the optical touch screen is not in operation for a period of time, it enters the sleep mode. When the user wants to use the optical touch screen again, the user only needs to put the indication object on the optical touch screen to wake up the optical touch screen from the sleep mode. However, when detecting on a wakeup time, the optical touch screen produces a high current consumption, and thus the specification of 2.5 mA current consumption cannot be met.

### SUMMARY OF THE INVENTION

Accordingly, the present invention is an optical touch device, to solve the problem in the prior art that a high current consumption is caused when detecting a wakeup time, and thus the specification of the 2.5 mA current consumption cannot be met.

The present invention provides an optical touch device, which comprises more than one image sensor and a processing unit.

The processing unit connects the image sensors.

When the optical touch device is in a sleep mode, one of the image sensors that present the sleep mode is enabled, such that the enabled image sensor detects an indication object on a touch area.

When the image sensor detects that the indication object exists on the touch area, the image sensor notifies the processing unit to wake up the entire optical touch device.

When the optical device is in the sleep mode, the enabled image sensor may detect the indication object with a first frequency. Moreover, the first frequency is lower than a detection frequency when the image sensor is in a normal operation mode.

Furthermore, when detecting that the indication object exists on the touch area, the image sensor may send a signal to the processing unit, such that the processing unit wakes up the entire optical device according to the signal sent by the image sensor. When the optical touch device is in the sleep mode, the signal sent by the image sensor excludes coordinate information of the indication object.

In addition, the optical touch device may further comprise a timer. When the optical touch device is in the sleep mode, the timer is adapted to periodically actuate one of the image sensors, such that the enabled image sensor detects an indication object on a touch area to determine a wakeup time of the entire optical touch device.

Furthermore, the image sensor may have an interception pin, electrically connected to the processing unit. When the optical touch device is in the sleep mode, when the image sensor detects that the indication object exists on the touch area, the image sensor sends an interception signal to the processing unit through the interception pin, such that the processing unit wakes up the entire optical touch device according to the interception signal.

Furthermore, the image sensor may also notify the processing unit through serial transmission.

Furthermore, the image sensor may only detect a local area of the touch area, to determine whether the indication object exists on the local area of the touch area.

The optical touch device may comprise more than one light-emitting element. Herein, each image sensor is corresponding to one of the light-emitting elements. When the optical device is in the sleep mode, an image sensor and a corresponding light-emitting element are enabled simultaneously, such that the enabled image sensor detects the indication object on the touch area according to light emitted by the corresponding light-emitting element.

According to the optical touch device of the present invention, when the optical touch device is in the sleep mode, only one of all the image sensors of the optical touch device is enabled to detect the indication object, to determine the wakeup time of the entire optical touch device, so as to reduce the current consumption when the optical device is in the sleep mode and meet the specification of 2.5 mA current consumption.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is a schematic structural view of an optical touch device according to a first embodiment of the present invention;

FIG. 2 is a schematic structural view of an optical touch device according to a second embodiment of the present invention;

FIG. 3 is a schematic structural view of an optical touch device according to a third embodiment of the present invention;

FIG. 4 is a schematic structural view of an optical touch device according to a fourth embodiment of the present invention;

FIG. 5 is a flow chart of a method for waking up an optical touch device from a sleep mode according to an embodiment of the present invention;

FIG. 6 is a flow chart of Step 510 of an embodiment of the method for waking up the optical touch device from the sleep mode of the present invention;

FIG. 7 is a schematic block diagram of an image sensor of the optical device according to the first embodiment of the present invention;

FIG. 8 is a schematic block diagram of an image sensor of the optical device according to the first embodiment of the present invention;

FIG. 9 is a schematic block diagram of an image sensor of the optical device according to the third embodiment of the present invention;

FIG. 10 is a flow chart of Step 520 of the method for waking up the optical touch device from the sleep mode according to the first embodiment of the present invention;

FIG. 11 is a flow chart of Step 520 of the method for waking up the optical touch device from the sleep mode according to the second embodiment of the present invention; and

FIG. 12 is a flow chart of Step 520 of the method for waking up the optical touch device from the sleep mode according to the third embodiment of the present invention.

### DETAILED DESCRIPTION OF THE INVENTION

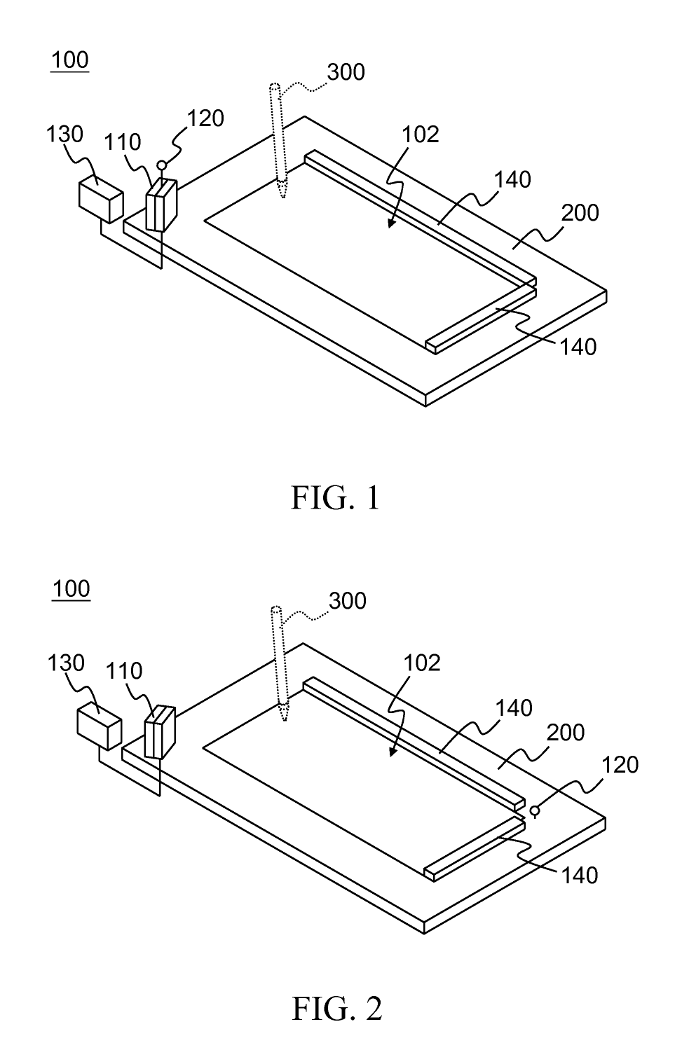

Referring to FIGS. 1, 2, 3 and 4, an optical touch device 100 may be located on a display screen 200 (such as an LCD screen, a cathode-ray tube display screen, and an electronic whiteboard).

The optical touch device 100 is used for providing a touch area 102. Moreover, an image sensor 110 and a light-emitting element 120 are disposed in a corner of the touch area 102. The image sensor 110 is electrically connected to a processing unit 130. The processing unit 130 is used for controlling the operation of the optical touch device 100.

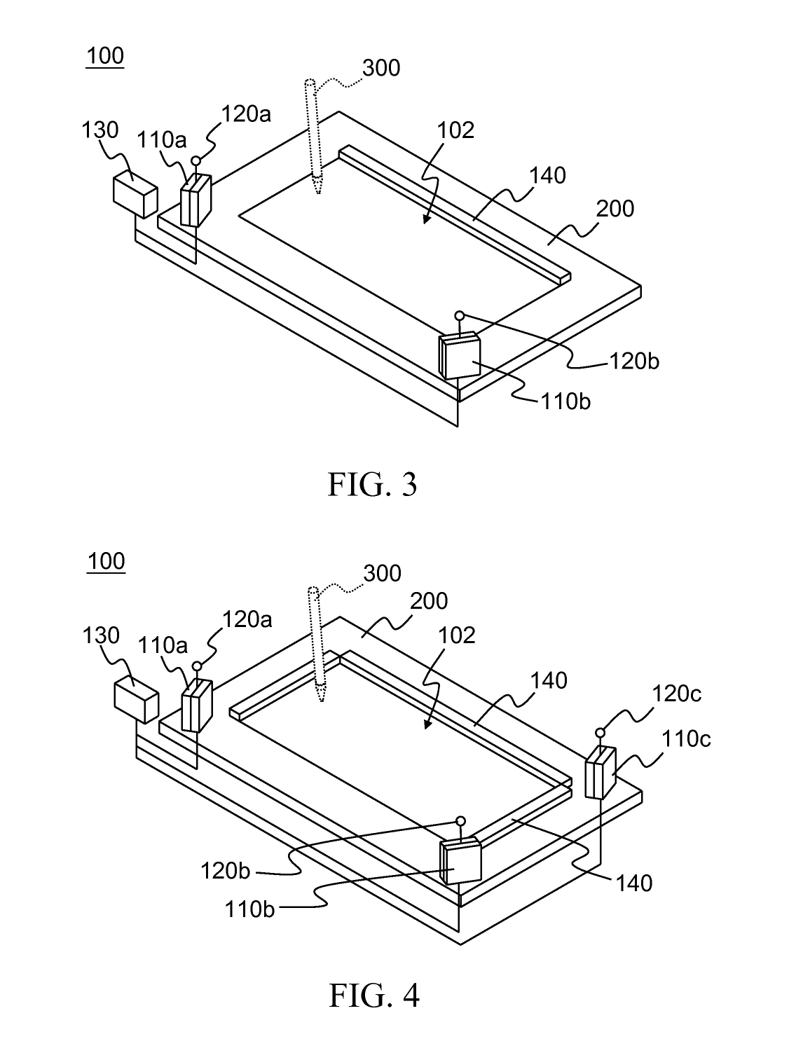

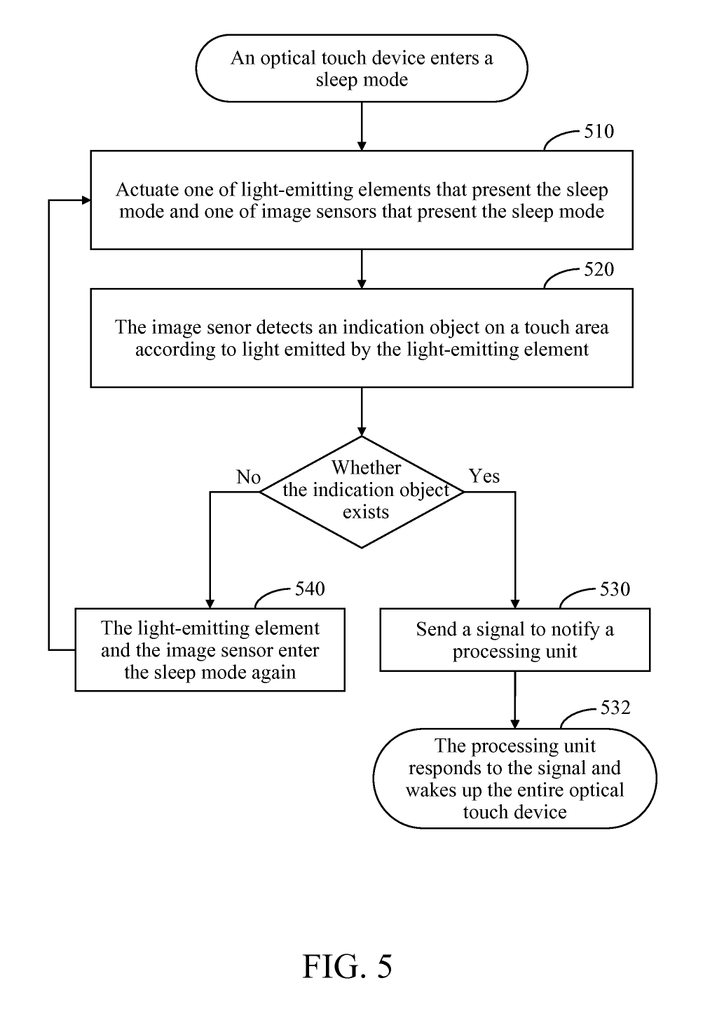

A single image sensor 110 may be disposed in one optical touch device 100 (as shown in FIGS. 1 and 2), or more than two image sensors 110a, 110b, and 110c (all referred to as 110) may also be disposed (as shown in FIGS. 4 and 5). A single light-emitting element 120 may be disposed in one optical touch device 100 (as shown in FIGS. 2 and 3), or more than two light-emitting elements 120a, 120b, and 120c (all referred to as 120) may also be disposed (as shown in FIGS. 3 and 4).

Each image sensor 110 is corresponding to one of the light-emitting elements 120. The image sensor 110 detects an indication object 300 on the touch area 102 according to light emitted by the corresponding light-emitting element 120. In addition, the optical touch device 100 may also have a waveguide element or reflecting element 140. The waveguide element or reflecting element 140 is selectively disposed around the touch area 102.

Referring to FIG. 5 together, when the optical touch device 100 is in the sleep mode, the light-emitting element 120a of the light-emitting elements 120 that present the sleep mode is enabled (Step 510), such that the light-emitting element 120a emits light onto the touch area 102 (Step 520). In addition, the image sensor 110a of the image sensors 110 that present the sleep mode is enabled (Step 510), such that the image sensor 110a detects the indication object 300 on the touch area 102 according to the light emitted by the corresponding light-emitting element 120a (Step 520), so as to determine whether an indication object 300 exists on the touch area 102. Herein, the light-emitting element 120a and the image sensor 110a corresponding to each other may operate synchronously, that is, be enabled at the same time.

When the image sensor 110a detects that the indication object 300 exists on the touch area 102, the image sensor 110a sends a signal to notify the processing unit 130 (Step 530), such that the processing unit 130 responds to the signal and wakes up the entire optical touch device, such as, the image sensor 110 that still presents the sleep mode, the light-emitting elements 120, and other components (Step 532). When the optical touch device 100 is in the sleep mode, the signal sent by the image sensor 110a may exclude coordinate information of the indication object 300.

When the image sensor 110a does not detect that the indication object 300 exists on the touch area 102, the light-emitting element 120a and the image sensor 110a enter the sleep mode again (Step 540).

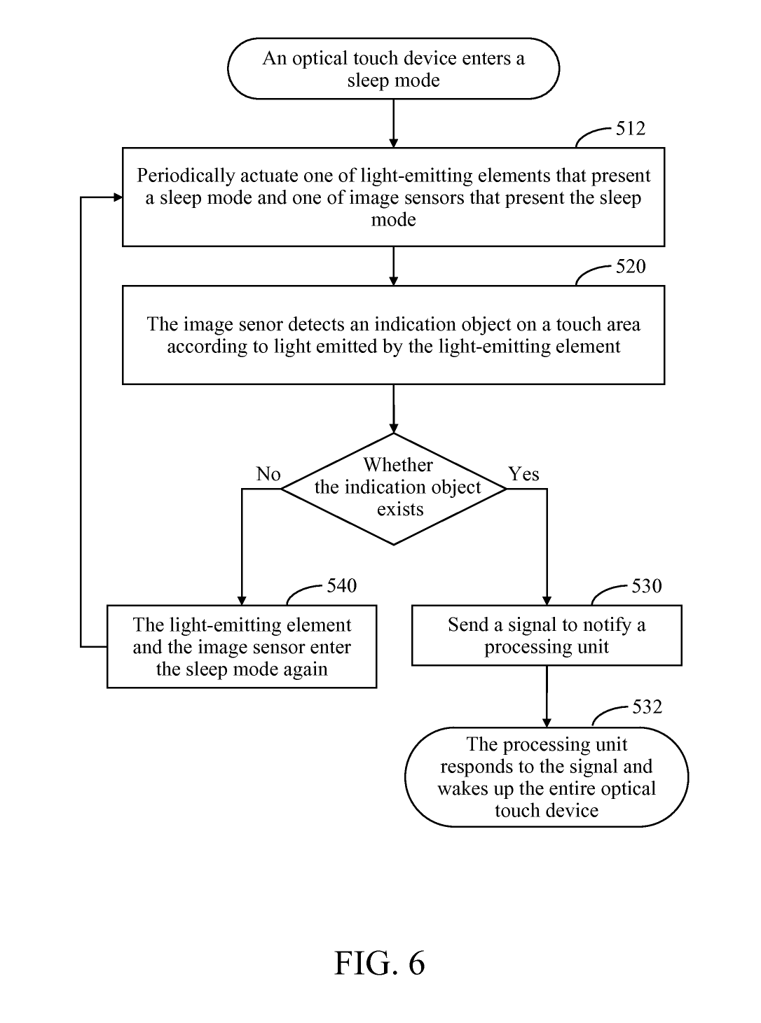

Referring to FIG. 6, in Step 510, the image sensor 110a may be enabled periodically (Step 512), such that the image sensor 110a detects the indication object 300 with a first frequency (Step 520). The first frequency is lower than a detection frequency when the image sensor 110a is in the normal operation mode. For example, when the optical touch device 100 is in the normal operation mode, the detection frequency of the image sensor may be 240 frames per second; and when the optical touch device is in the sleep mode, the first frequency is much lower than 240 frames per second, for example, the image sensor detects one or two frames every second.

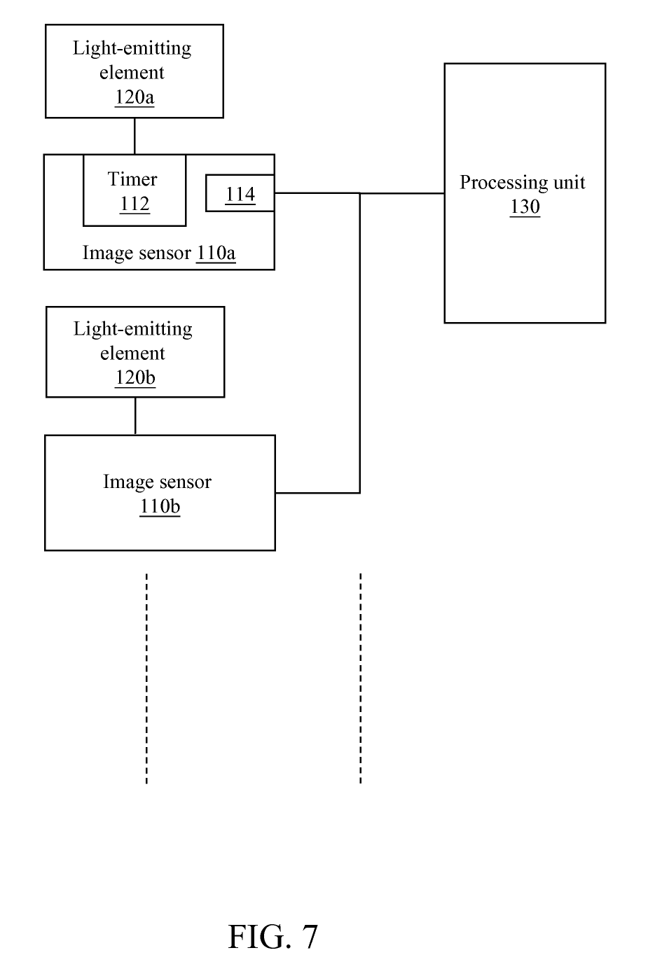

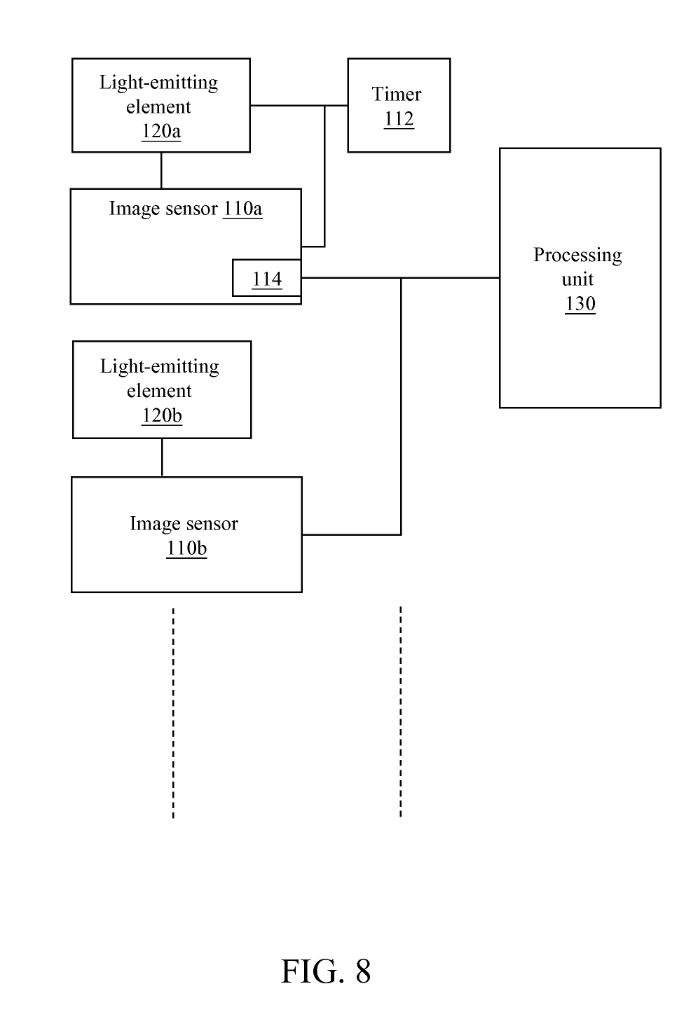

Referring to FIGS. 7 and 8, a timer 112 may be disposed in the optical touch device 100. When the optical touch device 100 is in the sleep mode, the timer 112 may periodically actuate the corresponding image sensor 110a to detect the indication object 300 on the touch area 102, so as to determine the wakeup time of the optical touch device 100. That is to say, the low-power consumption timer 112 may be used to periodically wake up the image sensor 110a to detect the indication object 300. Herein, the timer 112 may be disposed in the image sensor 110a that is waked up by the timer 112, or may be disposed outside the image sensor 110a.

Furthermore, an interception pin 114 may be specially designed in the image sensor 110a. The interception pin 114 is electrically connected to the processing unit 130. When the optical touch device 100 is in the sleep mode, and the image sensor 110a detects that the indication object 300 exists on the touch area 102, the image sensor sends an interception signal to the processing unit 130 through the interception pin 114, such that the processing unit 130 wakes up the entire optical touch device 100 according to the interception signal. That is to say, when the image sensor 110a detects that the indication object 300 exists on the touch area 102, the interception signal is used to wake up the processing unit 130 that presents the sleeping mode, and then the processing unit 130 wakes up the entire optical touch device 100, such as, the image sensor 110 that still presents the sleep mode, the light-emitting element 120, and other components.

In addition, when the optical touch device is in the sleep mode, the enabled image sensor 110a may also communicate with the processing unit 130 through serial transmission.

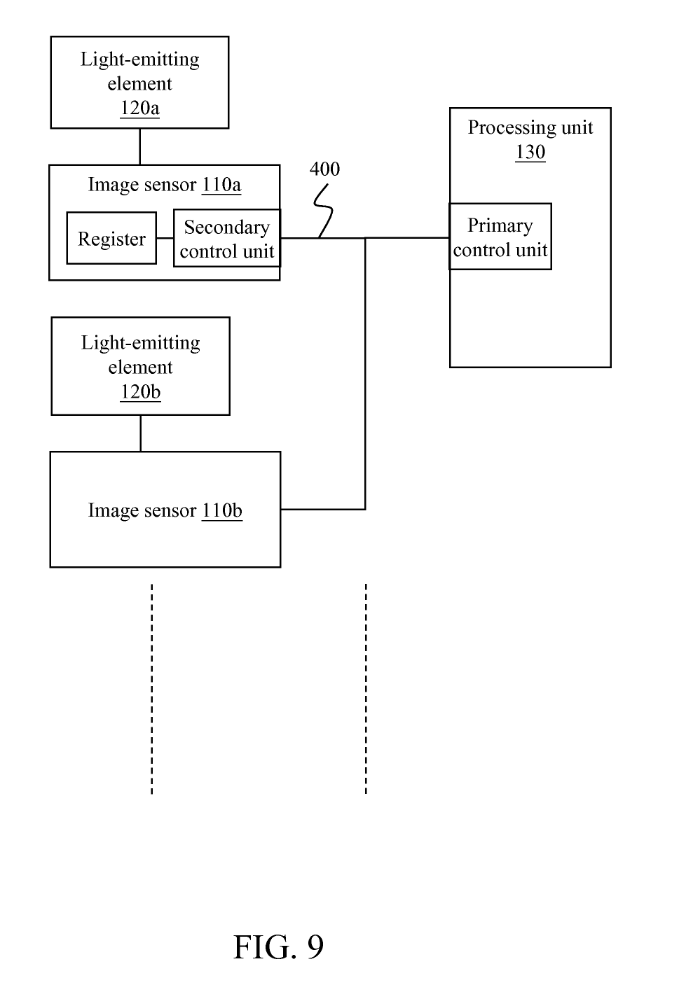

For example, referring to FIG. 9, when the optical touch device is in the sleep mode, the processing unit 130 may regularly send a detection command to the image sensor 110a through an Inter-Integrated Circuit (I2C) bus 400, such that the image sensor 110a periodically detect the indication object 300. When the image sensor detects that the indication object exists on the touch area, the image sensor notifies the processing unit through the I2C bus to wake up the entire optical touch device.

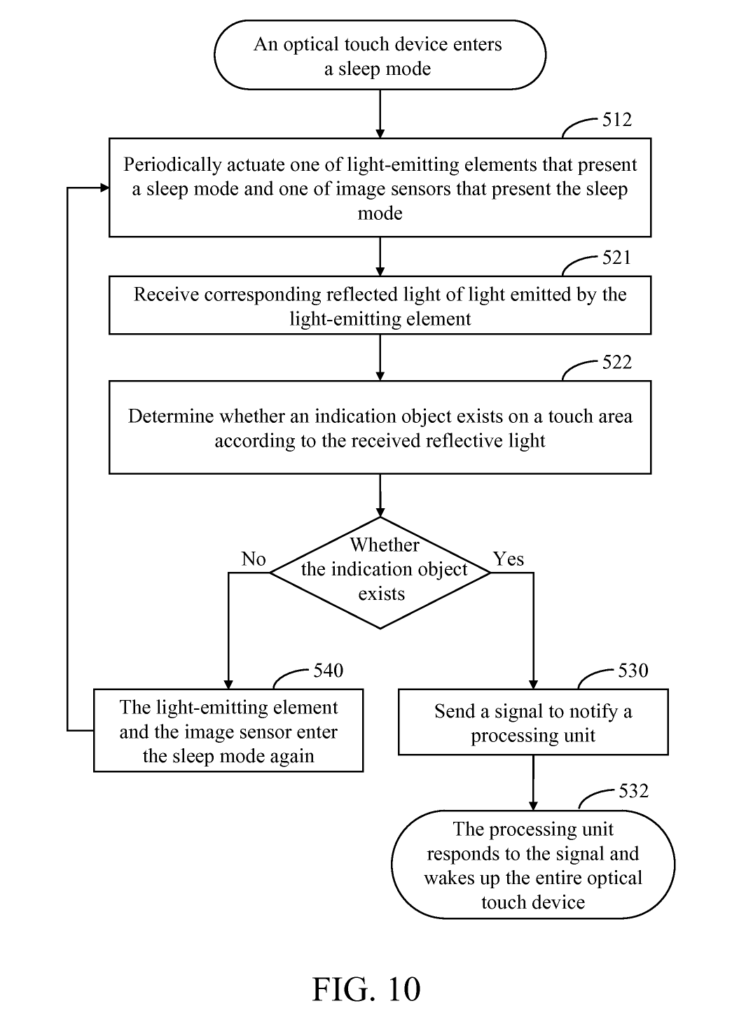

Referring to FIG. 10, in Step 520, the image sensor 110a may receive reflected light corresponding to the light emitted by the light-emitting element 120a (Step 521), and further determine whether the indication object 300 exists on the touch area 102 according to the received reflected light (Step 522). For example, when the indication object 300 is on the touch area 102, the image sensor 110a receives the reflected light produced by reflecting the light by the indication object 300.

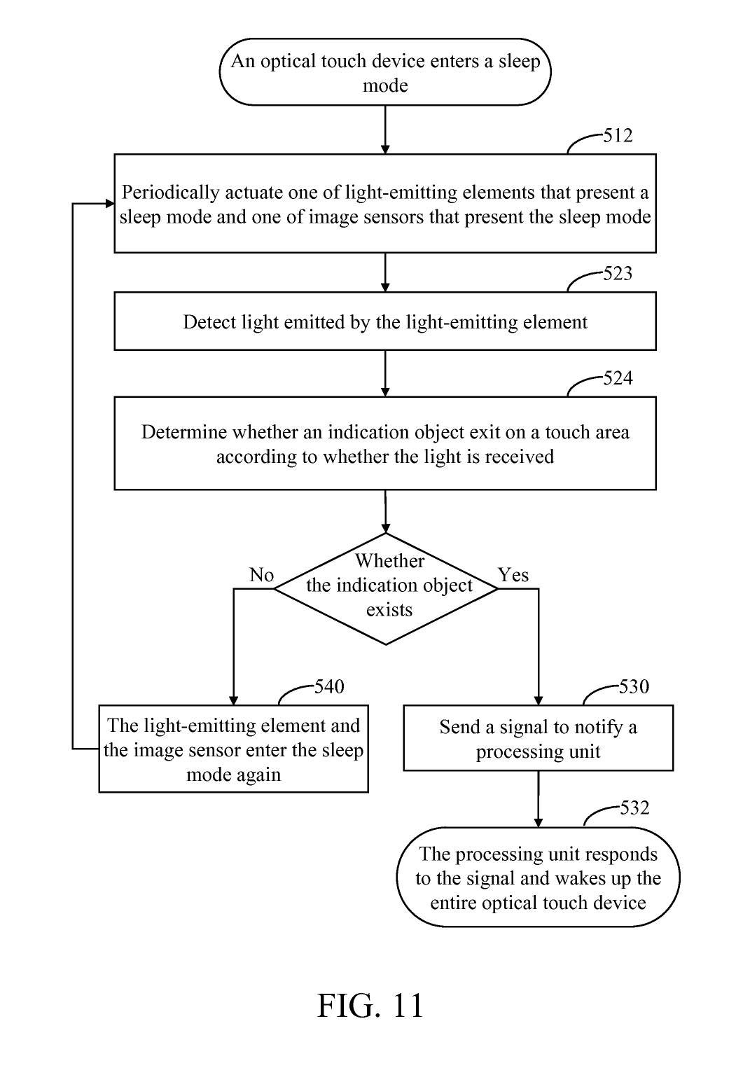

Furthermore, referring to FIG. 11, in Step 520, the image sensor 110a may detect the light emitted by the light-emitting element 120a (Step 523), and further determine whether the indication object 300 exists on the touch area 102 according to whether the light is received (Step 524).

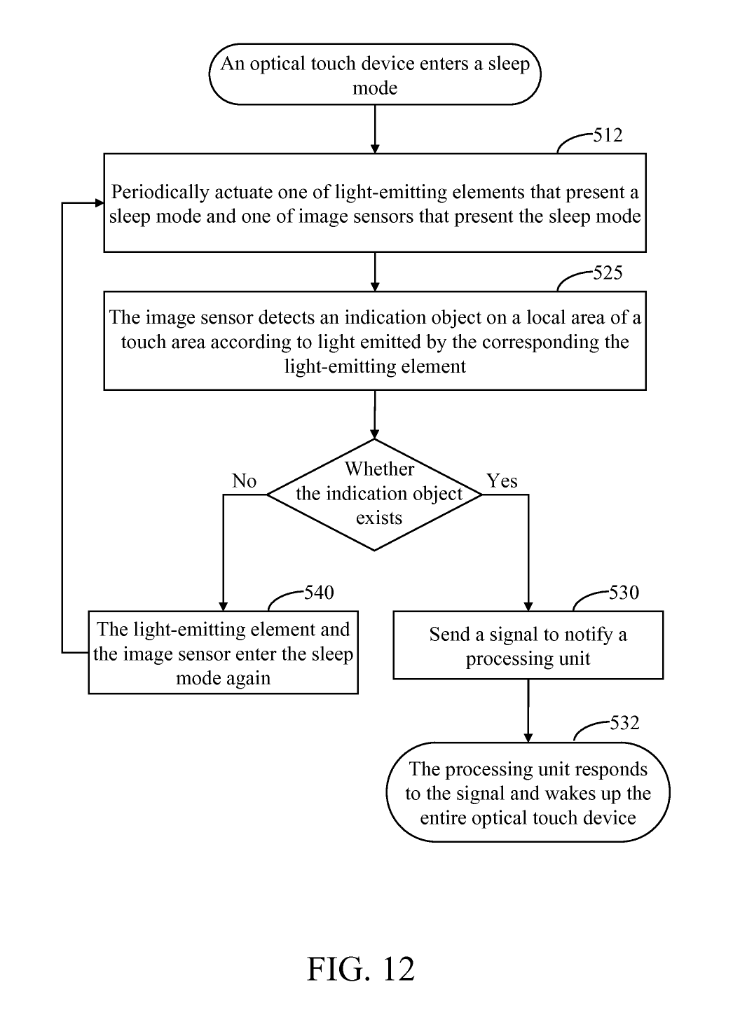

Furthermore, referring to FIG. 12, in Step 520, the image sensor 110a may only detect a local area of the touch area 102 (Step 525), to determine whether the indication object 300 exists on the local area of the touch area 102.

According to the method for waking up the optical touch device from the sleep mode and the optical touch device of the present invention, when the optical touch device is in the sleep mode, only one of all the image sensors of the optical touch device is enabled to detect the indication object, to determine the wakeup time of the entire optical touch device, so as to reduce the current consumption when the optical device is in the sleep mode and meet the specification of 2.5 mA current consumption.

What is claimed is:

1. An optical touch device, applied to provide a touch area, comprising:
at least one image sensor; and
a processing unit, electrically connected with the image sensor;
wherein when the optical touch device is in a sleep mode, one of the image sensors that present the sleep mode is enabled, such that the enabled image sensor detects an indication object on the touch area; and
when the image sensor detects that the indication object exists on the touch area, the image sensor notifies the processing unit to wake up the entire optical touch device.

2. The optical touch device according to claim 1, wherein when the optical touch device is in the sleep mode, the enabled image sensor detects the indication object with a first frequency that is lower than a detection frequency when the image sensor is in a normal operation mode.

3. The optical touch device according to claim 1, further comprising a timer, wherein when the optical touch device is in the sleep mode, the timer is used to periodically enable the image sensor in the image sensors, such that the enabled image sensor detects the indication object on the touch area, so as to determine a wakeup time the optical touch device.

4. The optical touch device according to claim 3, wherein the timer is disposed in the image sensor enabled by the timer.

5. The optical touch device according to claim 3, wherein the timer is disposed outside the image sensor enabled by the timer.

6. The optical touch device according to claim 1, wherein when the image sensor detects that the indicating sensor exists on the touch area, the image sensor sends a signal excluding coordinate information of the indication object to the processing unit, such that the processing unit wakes up the entire optical touch device according to the signal.

7. The optical touch device according to claim 6, wherein the image sensor has an interception pin, electrically connected to the processing unit, and for transmitting the signal.

8. The optical touch device according to claim 1, wherein the image sensor notifies the processing unit with serial transmission.

9. The optical touch device according to claim 8, wherein the image sensor notifies the processing unit through an Inter-Integrated Circuit (I2C) bus.

10. The optical touch device according to claim 1, wherein when the optical touch device is in the sleep mode, the enabled image sensor detects a local area of the touch area, to determine whether the indication object exists on the touch area.

11. The optical touch device according to claim 1, further comprising:
at least one light-emitting element;
wherein each image sensor is corresponding to one of the light-emitting elements, and when the optical touch device is in the sleep mode, an image sensor and an corresponding light-emitting element are enabled simultaneously, such that the enabled image sensor detects the indication object on the touch area according to light emitted by the corresponding light-emitting element.

12. An optical touch device, comprising:
at least one light-emitting element, at least one image sensor, and a processing unit, wherein each image sensor is corresponding to one of the light-emitting elements, the processing unit is connected with these image sensors, the optical touch device further comprises a timer, and when the optical touch device is in a sleep mode, the timer is used to periodically actuate one of the image sensors, such that the enabled image sensor detects an indication object on a touch area to determine a wakeup time of the optical touch device.

13. The optical touch device according to claim 12, wherein the image sensor has an interception pin, and the interception pin is electrically connected to the processing unit, when the optical touch device is in the sleep mode, and the image sensor detects that the indication object exists on the touch area, the image sensor sends an interception signal to the processing unit through the interception pin, such that the processing unit wakes up the entire optical touch device according to the interception signal.
